(19) United States
(12) Patent Application Publication
(10) Pub. No.: US 2010/0095535 A1
(43) Pub. Date: Apr. 22, 2010

(54) DEVICE FOR CUTTING THE INNER CELL OF A CELLULAR COVERING FOR ARCHITECTURAL OPENINGS INCLUDING INNER AND OUTER CONCENTRIC CELLS

(75) Inventors: Terry L. Akins, Louisville, CO (US); Donald J. Clark, Thornton, CO (US); Wayne R. Rayman, Broomfield, CO (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(73) Assignee: HUNTER DOUGLAS INC., UPPER SADDLE RIVER, NJ (US)

(21) Appl. No.: 12/524,990

(22) PCT Filed: Feb. 11, 2008
(86) PCT No.: PCT/US08/53559

§ 371 Date: Jul. 29, 2009

Related U.S. Application Data
(60) Provisional application No. 60/889,025, filed on Feb. 9, 2007.

(51) Int. Cl. B26B 5/00; E06B 9/24

(52) U.S. Cl. 30/279.2; 160/84.05

(57) ABSTRACT

A cutter tool for cutting the innermost cell of two concentric cells as found in cell-in-cell coverings for architectural openings includes an elongated main body with lateral side extensions defining a space into which an inner cell of a dual cell can pass. Within that space, cutting blades are positioned along opposite sides of the main body of the tool so that relative movement of the tool along a dual cell cuts the inner cell along opposite sides thereof without damaging an outer concentric cell so that an anchor bar can be positioned within the dual cell in engagement with the outer cell for connecting the outer cell to an upper rail or bottom rail of the covering.

### CROSS REFERENCE TO RELATED APPLICATION

This application is a PCT International Application, which claims priority to U.S. provisional application No. 60/889,025 ('025 application), filed Feb. 9, 2007. The '025 application is hereby incorporated by reference as if fully disclosed herein.

### BACKGROUND OF THE INVENTION

1. Field of the Invention

The present invention relates generally to retractable cellular shades for architectural openings and the like and more particularly to a cutting tool or device for severing the inner one of two concentric cells used in the formation of a dual cell shade without damaging the outer cell.

2. Description of the Relevant Art

Coverings for architectural openings such as windows, doors, archways, and the like, have assumed many different forms over an extended period of time. Originally, such coverings were simply fabric materials draped across the architectural opening but now retractable coverings have become very popular. Retractable coverings are those that can be extended across an architectural opening or retracted adjacent one or more sides of the opening with many of these coverings also being movable between open and closed positions when in the extended position to permit or occlude vision and light through the covering.

An example of an early retractable covering is the commonly used venetian blind or mini-blind wherein a plurality of slats are horizontally suspended in vertically spaced relationship by tape or cord ladders having cross rungs on which the slats are supported. The rungs can be pivoted so as to move the slats between open and closed positions when the covering is extended across an architectural opening or the slats can be gathered adjacent one or more sides of the opening in a retracted position of the covering.

Recently, cellular shades have become popular with cellular shades assuming various forms and configurations. A typical cellular shade has a plurality of horizontally disposed transversely collapsible tubular cells made of a flexible material and interconnected along top and bottom sides to adjacent tubular cells. When the cellular shade is extended across an architectural opening, the cells are allowed to expand transversely and so as to in aggregate fully occupy the architectural opening. The covering can also be moved to a retracted position by moving a bottom rail toward a head rail and in doing so gathering and collapsing the cells between the bottom rail and head rail. Such cellular coverings can be of a conventional bottom up style wherein the head rail is fixed and the bottom rail is moved up and down to retract and extend the covering or it can be a top down/bottom up covering wherein a rail along the top edge of the cellular fabric material can be moved up and down as well as the bottom rail along the bottom edge of the cellular fabric so the fabric can be extended or retracted to any desired degree and positioned at any desired position within the architectural opening.

There are other numerous forms of cellular shades including a cellular shade wherein each cell is in fact a double cell with an inner cellular component and an outer concentric cellular component. The inner and outer cellular components have a common longitudinal axis and are transversely collapsible when the covering is moved to a retracted position where the collapsed cells are confined between a bottom rail and a movable or fixed upper rail. The uppermost and lowermost cells in such a covering are typically connected to the upper and lower rail by extending a somewhat rigid anchor bar through the uppermost and lowermost cells mechanically connected to the upper and lower rails.

It has been common practice to severe the inner cell along its length so the anchor bar, which has a width commensurate with that of the outer cell, can be fully inserted into the outer cell thereby supporting the outer cell and the severed inner cell within an adjacent rail. Severing the inner cell without damaging the outer cell, however, is a difficult task and accordingly a convenient system for doing so has been desired in the trade.

The present invention has been developed to satisfy the need for a cutting tool for severing the inner cell of such a double-celled covering for architectural openings.

### SUMMARY OF THE INVENTION

The cutting tool or device of the present invention is adapted for use in cutting the inner cell of a cell-in-cell type covering for architectural openings. Cell-in-cell coverings are comprised of a plurality of concentric double cells attached to adjacent double cells along a longitudinal side with each double-cell combination being made of a flexible material so the double cells are transversely collapsible and expandable. The uppermost one of the double cells is secured to an upper fixed or movable rail while the lowermost double cell is affixed to a fixed or movable bottom rail. When the upper and bottom rails are separated, the fabric composed of the plurality of interconnected double cells can be extended across an architectural opening and when the upper and lower rails are moved toward each other, the double cells will collapse transversely so as to form a neat stack of collapsed cells between the upper and lower rails.

To desirably connect the uppermost double cell to the upper rail and the lowermost double cell to the lower rail, it has been found desirable to longitudinally cut the inner one of the two concentric cells at the top and bottom of the fabric formed from the plurality of such cells so that a severed upper half of the inner cell and a severed lowered half of the inner cell is left within the larger outer concentric cell. An anchor bar for connecting the severed dual cell to a rail can then be inserted into the outer one of the concentric cells so as to fill the entire width of the outer cell inasmuch as the inner cell is no longer present.

The cutting tool includes an elongated body having a leading end with a transverse peripheral dimension small enough to be inserted into the inner cell to be severed and a pair of lateral extensions which confine a pair of laterally extending cutting blades so the cutting tool can be advanced longitudinally through the inner cell and as it is advanced through the inner cell the cutting blades will automatically severe opposite sides of the inner cell along the length of the inner cell. The cutting blades are positioned within lateral extensions on the main body, which protect the outer cell so there is no damage to the outer cell as the cutter tool is advanced through the inner cell. A pair of guide arms on opposite sides of the main body function to position opposite sides of the inner cell in alignment with the cutting blades for reliable severance of the inner cell into upper and lower halves.

The cutting tool can be advanced through the inner cell by pushing it with an anchor bar so as the cutting tool is forced out of the downstream end of the cell, the anchor bar is left properly positioned within the outer cell.

Other aspects, features and details of the present invention can be more completely understood by reference to the detailed description of a preferred embodiment, taken in conjunction with the drawings and from the appended claims.

### BRIEF DESCRIPTION OF THE DRAWINGS

FIG. 1 is an isometric of the cutting tool of the present invention.

FIG. 2 is a section taken along line 2-2 of FIG. 1.

FIG. 3 is an enlarged section taken along line 3-3 of FIG. 1.

FIG. 4 is a section taken along line 4-4 of FIG. 3.

FIG. 5 is an exploded isometric of the cutting tool of the invention.

FIG. 6 is a fragmentary isometric of a cell-in-cell covering for an architectural opening.

FIG. 7 is an enlarged fragmentary section taken along line 7-7 of FIG. 6.

FIG. 8 is an enlarged fragmentary transverse section through the bottom rail and the lowermost cell of the covering shown in FIG. 7.

FIG. 9 is a fragmentary isometric of a cell-in-cell fabric material showing the cutting tool of the present invention being advanced into the uppermost and lowermost cells of the fabric.

FIG. 10 is a fragmentary section similar to FIG. 9 showing the cutting tool partially advanced into the uppermost cell of the fabric.

FIG. 11 is a transverse section taken along line 11-11 of FIG. 10 through the leading end of the cutting tool and one double cell as found in the fabric of FIG. 6.

FIG. 12 is an enlarged section taken along line 12-12 of FIG. 11.

FIG. 13 is an isometric similar to FIG. 10 with the cutting tool having been advanced further into the uppermost double cell of the fabric and showing an anchor bar in position for advancing the cutting tool through the uppermost cell.

FIG. 14 is an isometric similar to FIG. 13 with the anchor bar engaged with the cutting tool for advancing it through the uppermost double cell.

FIG. 15 is an isometric similar to FIG. 14 with the cutting tool being advanced out of the downstream end of the uppermost cell by the anchor bar.

FIG. 16 is an isometric looking downwardly from the rear on a second embodiment of the tool shown in FIGS. 1-15.

FIG. 17 is a right side elevation of the tool shown in FIG. 16.

FIG. 18 is a vertical section taken along line 18-18 of FIG. 16.

FIG. 19 is a horizontal section taken along line 19-19 of FIG. 16.

FIG. 20 is an exploded isometric looking upwardly from the front of the cutting tool of FIG. 16.

FIG. 21 is a fragmentary isometric showing the tool aligned with an upper cell of a cell-in-cell shade preparatory for cutting the upper inner cell of the shade.

FIG. 22 is a fragmentary isometric similar to FIG. 21 with the tool having been initially inserted into the upper inner cell of the shade.

FIG. 23 is an enlarged vertical section taken along line 23-23 of FIG. 22.

### DESCRIPTION OF THE PREFERRED EMBODIMENT

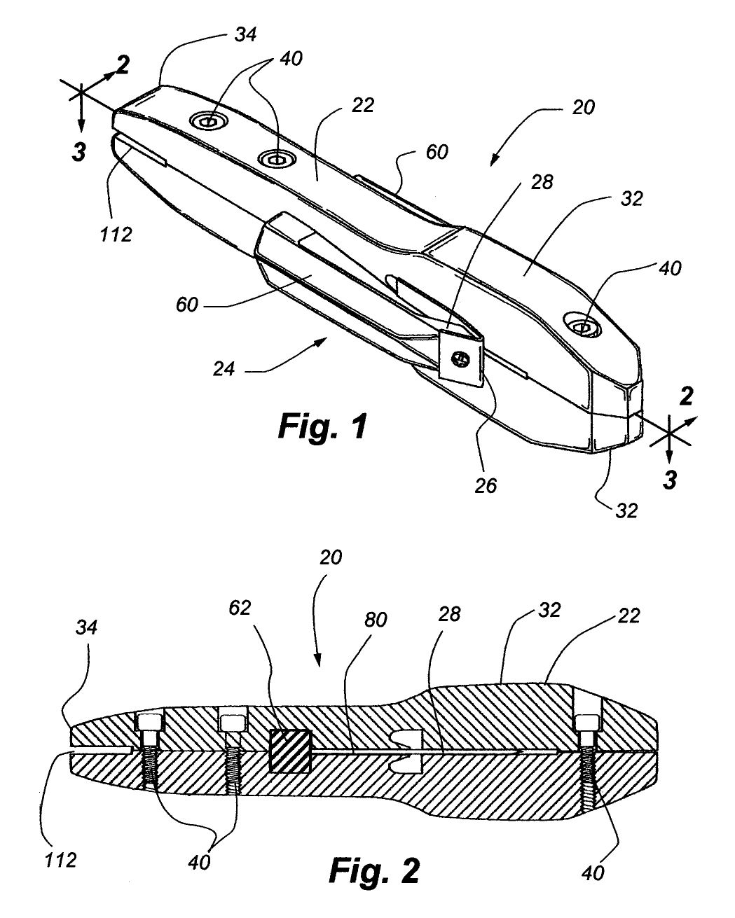

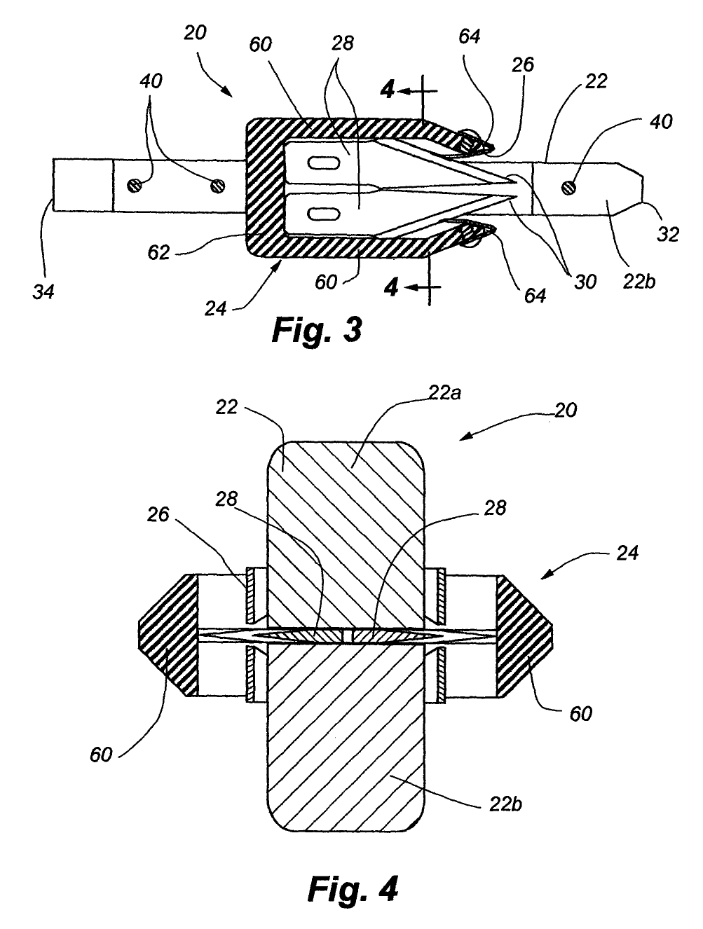

The cutting tool 20 of the present invention is best seen in FIGS. 1-5 to comprise a two-piece main body 22 having a lateral extension member 24 securable thereto and guide arms 26 secured to the lateral extension member on opposite sides of the main body. A pair of cutting blades 28 are positioned between the two halves 22 and 22b of the main body and confined by the lateral extension member so cutting edges 30 of the cutting blades are directed toward the leading end of the main body. As will be discussed later, the assembled cutting tool is adapted to be advanced through a double cell of a cell-in-cell fabric for an architectural covering so the cutting blades severe the inner cell while leaving the outer cell intact whereby an anchor bar used to secure the double-cell fabric to a top rail or bottom rail of the covering can be desirably inserted into the severed cell.

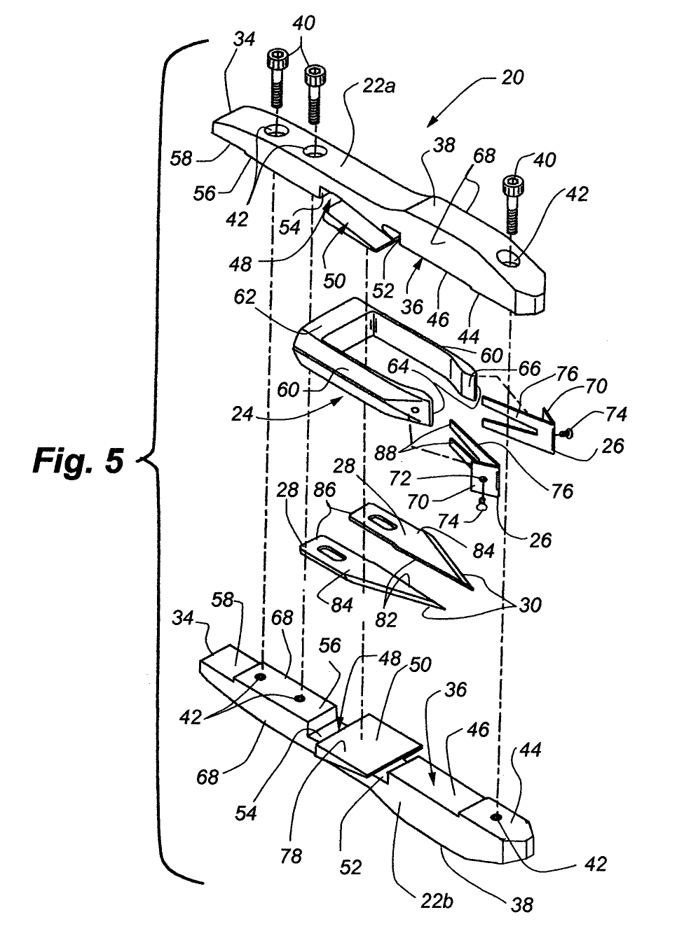

As is probably best appreciated by reference to FIG. 5, each half segment 22a and 22b of the main body is substantially identical having a forwardly and downwardly tapered leading end 32 and a squared off trailing end 34. Each half segment of the main body has a relatively flat inner surface 36 in which notches are formed and a contoured outer surface 38 with the leading end of the body having a maximum dimension from top to bottom that is greater than the trailing end. When the half segments of the main body are secured together, as with fasteners 40 passing through aligned passageways 42 therethrough (as seen in FIG. 2), the main body has a transverse peripheral dimension that varies along the length of the main body. By transverse peripheral dimension, it is meant the distance along the periphery of the object in a transverse plane.

With reference again to FIG. 5, it will be seen the generally flat inner face or surface 36 of each main body segment 22a and 22b has a first flat surface 44 at the leading end thereof, an adjacent first shallow recess 46 immediately rearwardly thereof and a relatively deep recess 48 rearwardly of the first shallow recess with the deep recess having an integral relatively wide plate 50 positioned therein to define channels 52 and 54 in front and behind the wide plate respectively. Immediately rearwardly of the deep recess is a second flat surface 56 that is coplanar with the first flat surface 44 at the leading end of the half segment and rearwardly of the second flat surface is a second shallow recess 58 that opens through the trailing end of the half segment. Each half segment has an identical relatively flat inner surface 36 so that when the inner surfaces 36 are placed in confronting relationship the two half segments define transverse channels or pockets for purposes to be described hereafter.

The lateral extension element or member 24 is a generally U-shaped element that opens forwardly so as to have two side arms 60 interconnected at a base or trailing end by a relatively broad block-like portion 62. The leading end of each side arm is tapered defining a relatively narrow vertical leading edge 64 and an inwardly and rearwardly tapering inner surface 66. The lateral extension element is designed to have its base 62 seated in the relatively deep channel 54 rearwardly of the wide plate 50 in each half segment of the main body so as to be confined therein when the half segments 22a and 22b are connected in confronting relationship. When properly seated and confined within the main body, the side arms 60 are spaced slightly from the sides 68 of the main body.

The guide arms 26 as seen in FIG. 5 are adapted to be secured to the leading end of each side arm 60 with each guide arm having an outer plate-like portion 70 with a passage 72 therethrough for receipt of a fastener 74 that can be advanced through the passage and into the associated leading end of a side arm. The guide arm has a forked rearwardly projecting extension 76 that is also angled inwardly so the forked ends of the guide arms are in engagement with an associated side 68 of the main body when the guide arms are secured to the side arms. The guide arms are made of a somewhat flexible material so that upon adequate pressure, they can be flexed away from the side 68 of the main body for a purpose to be described hereafter.

The exposed face 78 of each wide plate 50 is coplanar with the relatively shallow adjacent first recess 46 in its associated half segment 22a or 22b of the main body 22 and when the half segments are placed in confronting relationship, as possibly best seen in FIG. 2, a pocket or channel 80 is defined between the wide plates and the first shallow recesses to define a seat for the pair of cutting blades 28 as seen in FIG. 5. The cutting blades have a substantially longitudinally extending first edge 82 which is adapted to be abutted against the same adjacent edge of the other cutting blade and the outwardly and rearwardly tapered sharpened cutting edge 30 opposite the first edge that extends over halfway along the length of the cutting blade. At the rearmost extent of the sharpened edge, the cutting blade has a second longitudinally extending side edge 84. The longitudinally extending side edges 82 and 84 terminate in a perpendicular rear edge 86. The cutting blades are adapted to be placed in abutting side-by-side relationship between the wide plates 50 and the first shallow recesses 46 of the two main body half segments with the rear edge 86 of each blade abutted against the base 62 of the lateral extension element 24 as seen best in FIG. 2. The width of the blades are such that the cutting edges extend from a point inwardly of the sides 68 of the main body to a point contiguous with the associated side arm 60 of the lateral extension element. The second longitudinal side edge 84 of each cutting blade is abutted against the adjacent side arm so the cutting blades are held positively in position between the side arms of the lateral extension element, the base of the lateral extension element, the wide plates and the first shallow recesses of the main body half segments.

The cutting edges 30 of each cutting blade 28 extend into the forked rear extension 76 of the guide arms 26 so that each leg 88 in a fork is overlying or underlying a cutting blade. The cutting edge of the cutting blade will also be appreciated to extend between the side 68 of the main body and the inner side of a side arm 60 so as to fill that space whereby anything passing through that space in a front to rear direction relative to the main body 32 will engage the cutting edges of the cutting blades. As will also be appreciated, the guide arms are tapered so as to encourage anything approaching the guide arms between their leading end and the side of the main body to pass between the guide arms and the main body and engage a cutting edge of a blade.

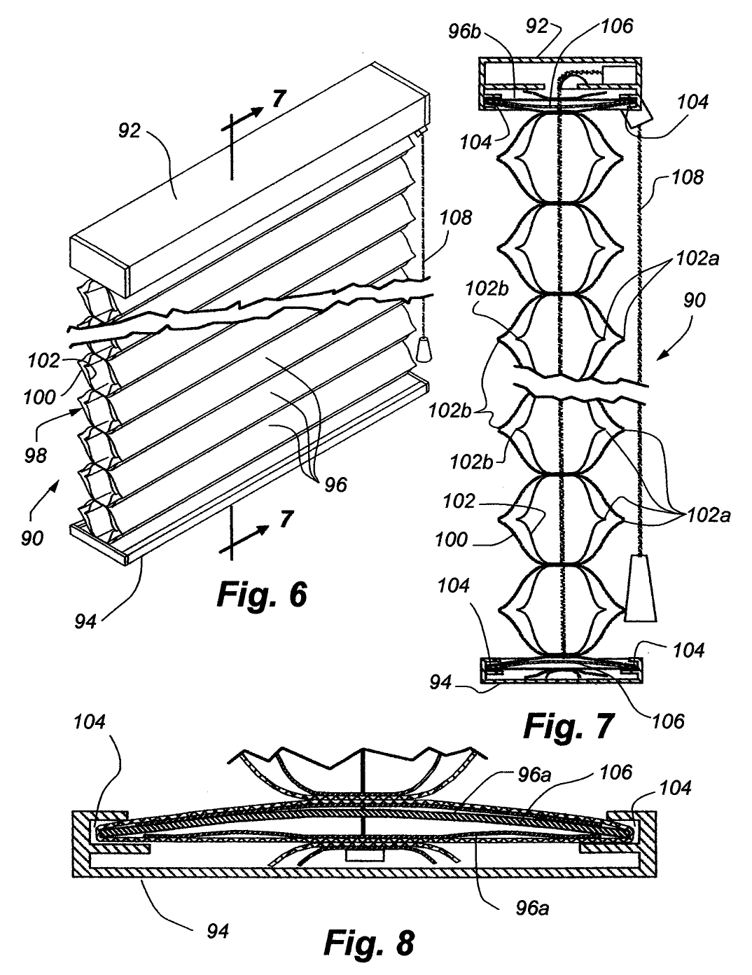

With reference to FIG. 6, a covering 90 for an architectural opening in which the cutting tool 20 of the present invention finds use is shown as including a head rail 92, which can be fixed in an architectural opening in any conventional manner, and a vertically movable but horizontal bottom rail 94 that extends parallel with the head rail. The bottom rail is affixed in a manner to be described hereafter to the lowermost cell 96a in the dual cell fabric extending between the head rail and the bottom rail while the uppermost dual cell 96b is attached to the head rail in a manner to be described hereafter.

A dual cell fabric 98, which is also referred to as a cell-in-cell fabric, used in the covering 90 is comprised of a plurality of concentric dual cells 96 that are connected to an adjacent cell along a top and bottom side. Each dual cell of the fabric is made of a flexible material such as a fabric material that is transversely collapsible but retains its configuration along its length when suspended between the head rail 92 and the bottom rail 94. The dual cells consist of an outer cell 100 having pleated front and rear edges 100a and 100b respectively and a smaller concentric inner cell 102 having corresponding front and rear pleated edges 102a and 102b, respectively, spaced inwardly from the front and rear edge of the outer cell, as best appreciated by reference to FIG. 7. Both the inner and outer cells are symmetric about a horizontal plane intersecting a central longitudinal axis of the cells as well as about a similar vertical plane. Each dual cell can be formed in accordance with the teachings in U.S. Pat. No. 6,345,486, issued Feb. 12, 2002, which is of common ownership with the present application and the disclosure of which is hereby incorporated by reference.

As best appreciated by reference to FIG. 7, both the head rail 92 and the bottom rail 94 have confronting inwardly opening longitudinally extending channels 104 formed therein which are adapted to receive edges of a substantially rectangular anchor bar 106 which has a lateral dimension slightly greater than the spacing between the channels 104 of the head rail and the bottom rail and having a length substantially commensurate with the length of the head rail and bottom rail. The anchor bar, as best appreciated by reference to FIGS. 7 and 8, is inserted into the uppermost cell 96b and the lowermost cell 96a of the cellular fabric 98 with the uppermost cell, as mentioned previously being connected to the head rail 92 and the lowermost cell being connected to the bottom rail 94. The anchor bar is inserted longitudinally into the uppermost and lowermost cells so as to laterally fill the cell and retain the cell between the confronting channels 104 of the head rail or bottom rail as the case may be. The anchor bar is slightly flexible so as to be biased within the confronting channels to provide positive retention of the fabric 98 to the head rail and bottom rail. In this manner, it will be appreciated the cellular fabric material is suspended from the head rail and extends to the bottom rail with the interconnected cells 96 of the fabric being parallel with the head rail and bottom rail. As is conventional in retractable coverings, one or more lift cords 108 extend from an accessible position outside the head rail, through the head rail and vertically downwardly through each cell for attachment to the bottom rail so when the lift cords are manually pulled, the lift cords raise the bottom rail toward the head rail. Of course, by manually allowing the lift cords to rise, where they are held by an operator, the bottom rail is allowed to drop by gravity in moving away from the head rail. Conventional cord locks (not seen) are provided in the head rail for securing the lift cords at any desired position so the fabric can be moved between a fully retracted position where the cells are collapsed adjacent to the head rail to a fully extended position where the cells are transversely open and the bottom rail is maximally spaced from the head rail as shown in FIG. 7.

As can be appreciated by reference to FIGS. 7 and 8, it is desirable that the flattened width of an outer cell 100 with the anchor bar 106 inserted therethrough is substantially equal to the spacing between the confronting channels 104 in the head rail and the bottom rail so the uppermost 96b or lowermost 96a cell as the case may be is positively retained in the head rail or bottom rail, respectively. This being the case, it is necessary to longitudinally cut the inner cell 102 in the uppermost and lowermost dual cells as the innermost cell due to its smaller width, would prevent the anchor bar from being inserted longitudinally into the outer cell in a position to fill the outer cell in a flattened condition. The cutting tool 20 of the present invention has been designed to cut the inner cell without damaging the outer cell so the anchor bar can be inserted into the uppermost and lowermost cells to connect these cells with the associated head rail or bottom rail as described above.

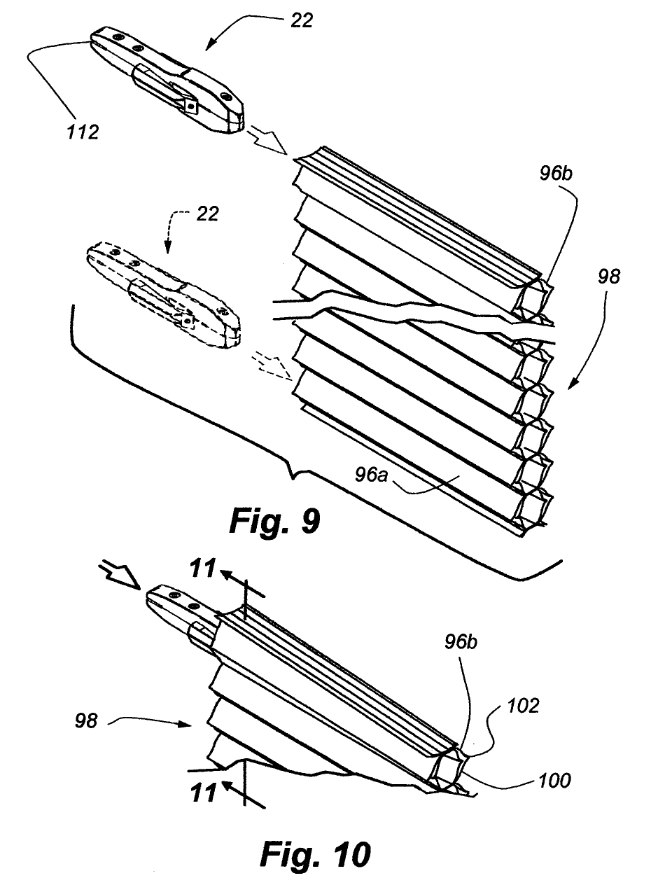

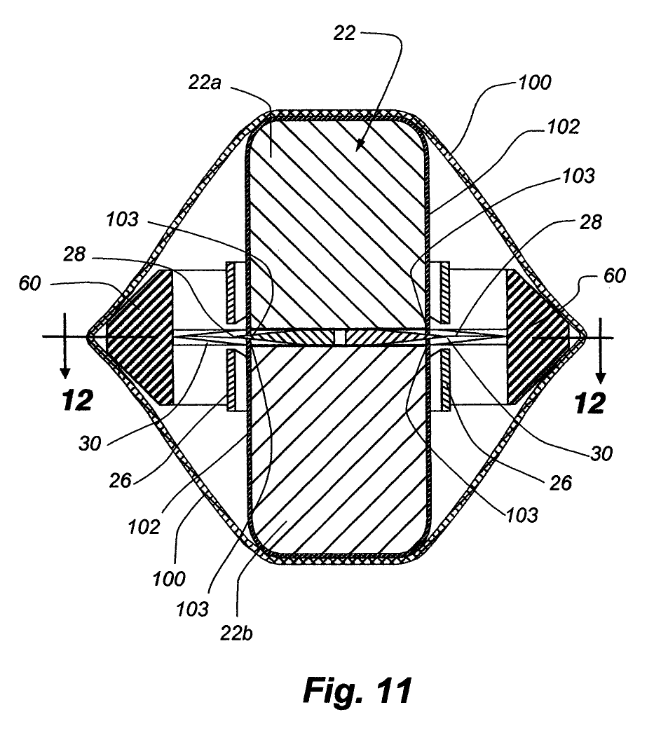

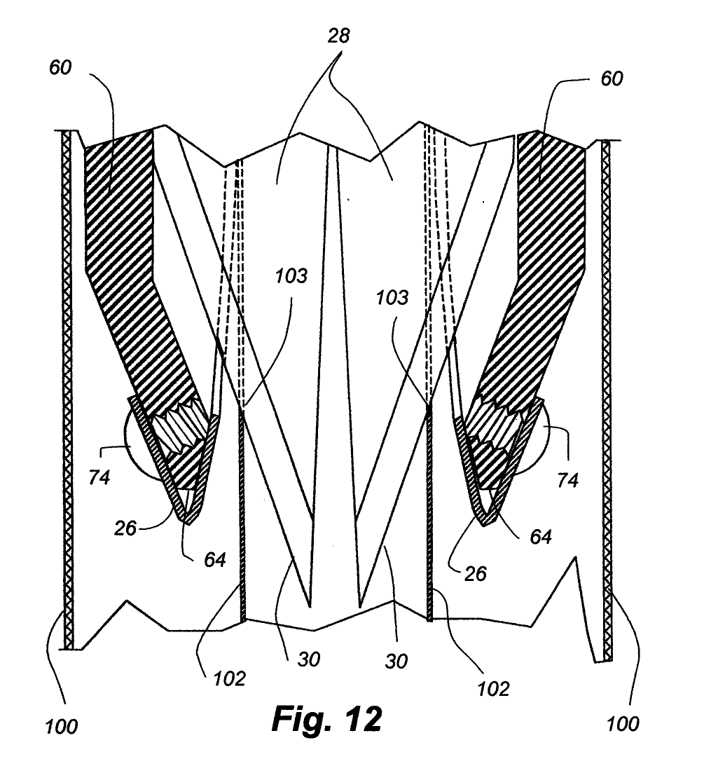

With reference to FIG. 9, it will be seen the cutting tool 20 is inserted into either the uppermost 96b or lowermost 96a cell with the leading end 32 of the cutting tool. The transverse peripheral dimension of the main body at the leading end of the cutter has a maximum transverse peripheral dimension which is, as appreciated by reference to FIG. 11, commensurate with the transverse peripheral dimension of the inner cell 102 of the dual cell in which the cutter is being inserted. In this manner, the inner cell is drawn tightly around the transverse peripheral dimension of the cutter tool at its maximum transverse peripheral dimension so opposite sides of the inner cell are fed between the sides 68 of the main body and the leading end of a guide arm 26 as the tool is inserted further and longitudinally into the dual cell. As will be appreciated, as the then confronting edge 103 (FIGS. 11 and 12) of the inner cell is advanced longitudinally along the length of the cutter with the cutter being advanced through the dual cell, the confronting edge is presented to the sharpened edges 30 of the cutting blades 28 which cleanly and dependably severe the inner cell along opposite longitudinal sides of the cell. As will be appreciated, as the tool is fully advanced through the dual cell, the inner cell is totally severed along opposite sides thereby enabling an anchor bar 106 to be inserted into the dual cell in engagement with the outer concentric cell 100.

As will be appreciated further from FIG. 11, the lateral extension member 24 will hold the outer cell 100 in a fully expanded condition where it is protected from the cutting edges 30 of the cutting blades by the side arms 60 so the outer cell is undamaged as the cutting tool is advanced longitudinally through a dual cell. This relationship is also illustrated in the sectional view in FIG. 12. It might, therefore, be said the cutting tool, at the maximum a transverse peripheral dimension of the leading end thereof where it overlaps the lateral extensions, defines a hypothetical enclosure having a transverse peripheral dimension substantially the same as the transverse peripheral dimension of the outer cell 100. This hypothetical enclosure would be identical to the cross section of the outer cell as seen in FIG. 11.

As will be appreciated from the earlier description, the transverse peripheral dimension of the main body 22 of the cutter tool is smaller at the trailing end than it is near the leading end so that after the inner cell 102 has been cut by the cutting blades 28, the dual cell will freely pass over the smaller transverse peripheral dimension of the cutter tool.

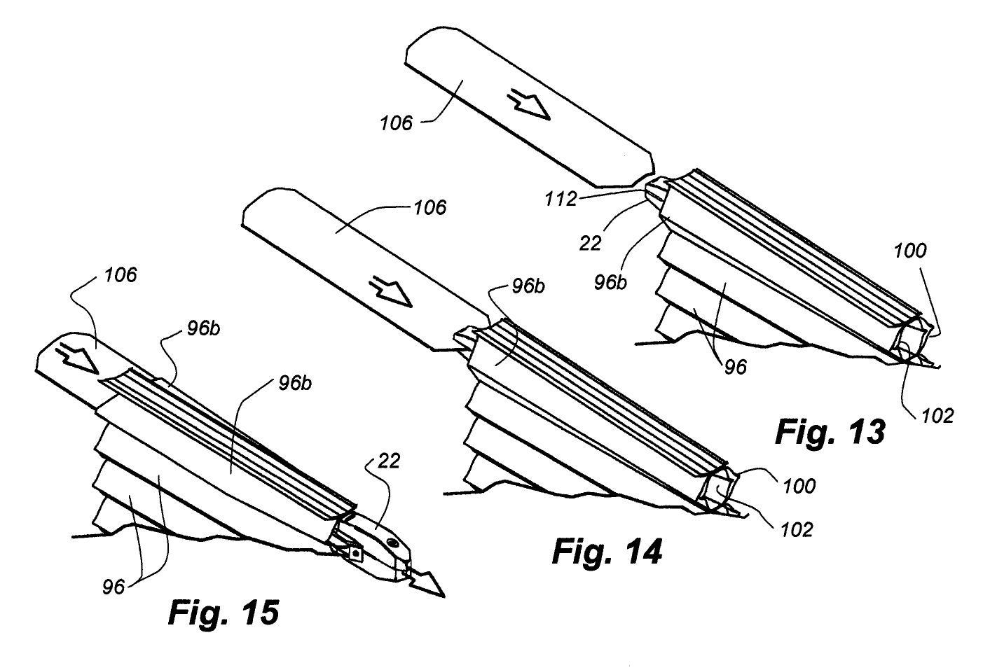

As will be appreciated from the previous description of the cutting tool 20, the trailing end 34 has the second relatively shallow confronting recesses 58 which define a pocket 112 therebetween opening through the trailing end of the tool as seen best in FIG. 2. This pocket can be utilized to advance the cutter tool through a dual cell being treated and at the same time position the anchor bar 106 within the cell. With reference to FIGS. 13-15, it will be seen the cutter tool has been advanced into one open end of the uppermost dual cell 96b so the pocket 112 is directed rearwardly and exposed. The anchor bar can then be inserted into the pocket as shown in FIG. 14 and by pushing the anchor bar, the cutter tool is advanced through the cell thereby severing the innermost cell 102 along its opposite sides and desirably positioning the anchor bar within the cell. FIG. 15 illustrates the cutter tool exiting the uppermost dual cell and with the anchor bar substantially fully inserted into the uppermost dual cell. Once the cutter tool is fully forced through the uppermost dual cell, the anchor bar is positioned within the uppermost dual cell in a manner that retains the uppermost cell in a generally flattened state.

The steps illustrated in FIGS. 13-15 can be executed so as to position the anchor bar 106 within the uppermost dual cell 96b and then the anchor bar with the dual cell mounted thereon advanced longitudinally along the head rail 92 so the side edges of the anchor bar, with the outer concentric cell disposed thereon, are positioned between the confronting channels 104 so the uppermost cell is secured to the head rail. Of course, the same procedure is followed for anchoring the lowermost dual cell 96a to the bottom rail 94.

A second embodiment 120 of the cutting tool of the present invention is shown in FIGS. 17-23 and will be seen to be functionally and structurally very similar to the first-described embodiment 20 except the lateral extension member 24 of the first embodiment has been made integral with the two halves of the main body as will be described in detail hereafter. In addition, one of the halves of the main body at its leading end has been made flexible and resilient to improve tightening or stretching of the inner cell of the dual-cell fabric 98, which facilitates improved cutting of the cell with the tool. Due to the close similarity of this embodiment with the first-described embodiment, like parts have been given like reference numerals.

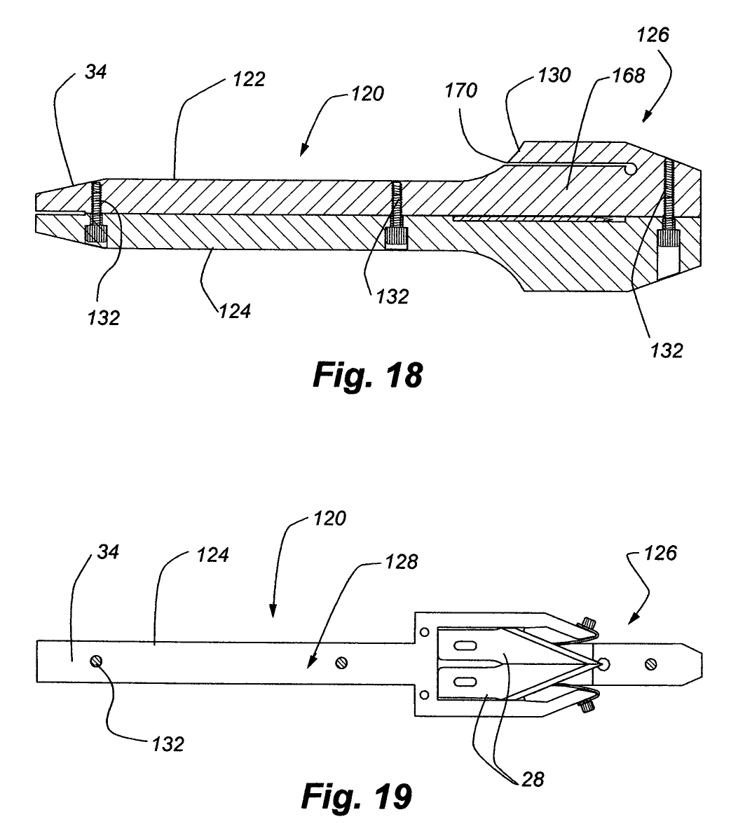

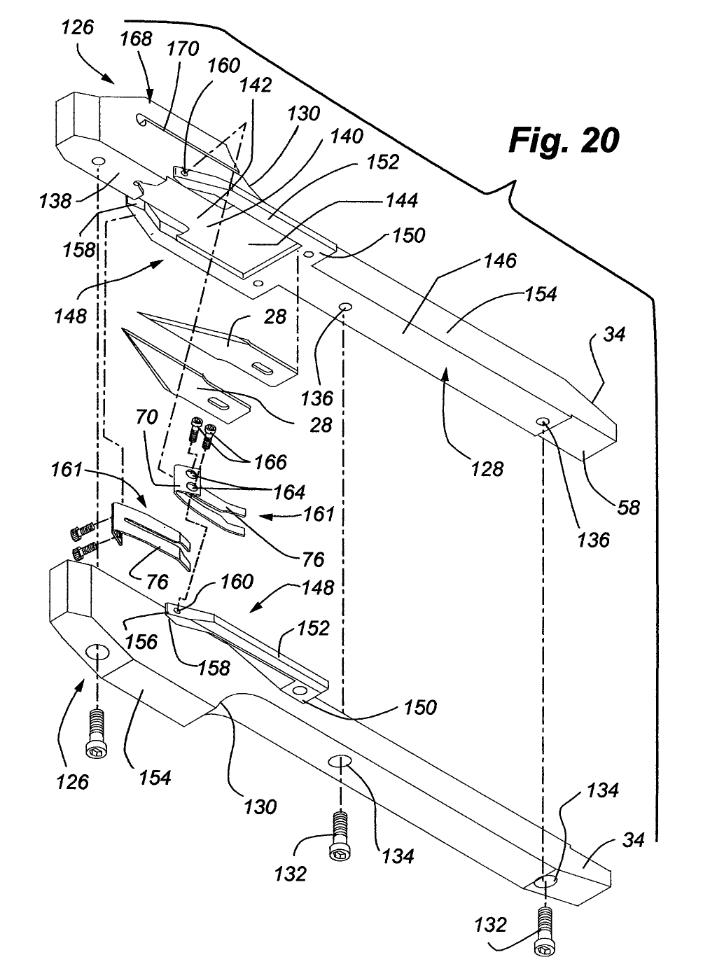

The tool 120 of the second embodiment is probably best seen in FIG. 20 to comprise an upper main body half 122 and a lower main body half 124, which are identical except to an extent to be pointed out hereafter and, accordingly, only one of the halves will be described in detail. Each main body half can be seen to have a tapered leading end 126 and a squared off trailing end 34. Each half or half segment of the main body has a relatively flat inner surface 128 in which notches are formed and a contoured outer surface 130 with the leading end 126 of the body being thicker from top to bottom than the trailing end 34. When the half segments of the main body are secured together, as with fasteners 132 passing through aligned passageways 134 and into blind holes 136 (as seen in FIG. 18), the main body has a transverse peripheral dimension that varies along the length of the main body.

Referring again to FIG. 20, it will be seen the generally flat inner face or surface 128 of each main body half segment 122 and 124 has a first flat surface 138 at the leading end thereof and an adjacent first shallow recess 140 immediately rearwardly thereof with the first shallow recess being relatively narrow nearer the leading end of the half segment at 142 and relatively wide at a trailing end thereof at 144. Rearwardly from the trailing end of the first shallow recess 140, there is a second flat surface 146 that is coplanar with the first flat surface 138 and rearwardly of the second flat surface is a second shallow recess 58 that opens through the trailing end 34 of the half segment. Each half segment has an identical relatively flat inner surface so that when the inner surfaces are placed in confronting relationship, the two half segments define transverse channels or pockets at the first 140 and second 58 shallow recesses for purposes to be described hereafter.

The second flat surface 146 at its leading end has outwardly directed lateral extensions 148 of the main body. Each lateral extension has a transverse component 150 and a forwardly directed component 152. The components are adjacent to trailing and lateral sides of the relatively wide area 144 of the first shallow recess 140. The forwardly directed components or arms 152 extend forwardly of the wide area 144 and are spaced from the sides 154 of the main body half where the first shallow recess 140 is relatively narrow. The leading ends of the arms 152 are tapered inwardly toward the leading end of the main body half and have a relatively narrow vertically extending leading edge 156. A gap 158 is defined between the leading edge of each arm 152 and the sides of the main body half. At the leading edge of each arm, a laterally extending internally threaded hole 160 is provided for a purpose to be described hereafter. The transverse component 150 and forwardly extending component or arms 152 of each lateral extension 148, when placed in confronting relationship with the corresponding parts of the other main body half, serve a purpose identical to the lateral extension element or member 24 of the first-described embodiment. As probably best appreciated by reference to FIGS. 19 and 20, the first shallow recess 140 is adapted to receive two cutting blades 28 identical to those of the first-described embodiment.

Guide arms 161 as seen in FIG. 20 are adapted to be secured to the leading end of each forwardly extending arm 152 with each guide arm having an outer plate-like portion 70 with a pair of passages 164 therethrough for receipt of fasteners 166 that can be advanced through an associated passage 164 and into an associated internally threaded hole 160 of each forwardly extending arm. The guide arm has a forked rearwardly projecting extension 76 identical to that of the guide arms 26 in the first-described embodiment that is also angled inwardly so the forked ends of the guide arms are in engagement with an associated side of the main body when the guide arms are secured to the forwardly extending arms. The guide arms are made of a somewhat flexible material so that upon adequate pressure, they can be flexed away from the side of the main body.

The passages 134 (FIG. 20) are provided through the lower half segment 124 for receipt of the fasteners 132 with the upper half segment 122 having the blind threaded holes 134 for receipt of the fasteners so that the two half segments can be secured together with the cutting blades 28 positioned therebetween. After the half segments are secured together, the guide arms 160 can be secured to the forwardly extending arms 152 to fully assemble the cutting tool.

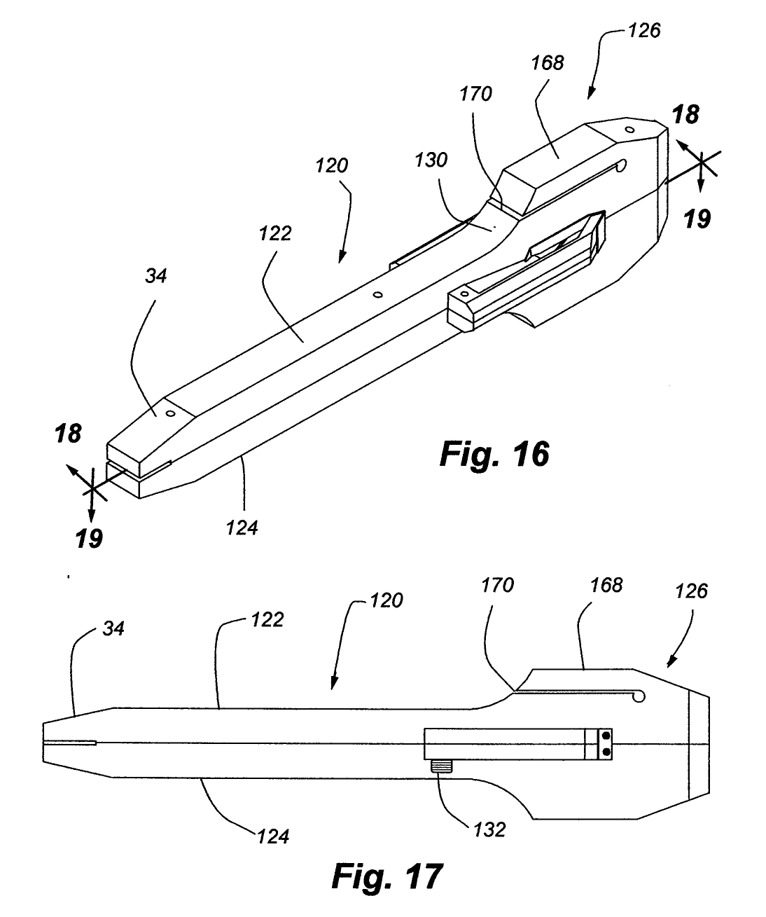

As seen in FIGS. 16, 17, 18, and 20, an enlarged head 168 forming part of the leading end 126 of the upper half segment 122 has a horizontal slot 170 formed therein from the rear end of the head toward the leading end of the head. Each half of the main body is made of a resilient but somewhat rigid material so that this slot allows the head at the leading end of the main body to flex downwardly while being biased into a neutral position of FIGS. 16-18 and 20. In this manner, when the cutting tool is used as described in connection with the first-disclosed embodiment, the resilient head 168 of the tool can actually hold the inner cell 102 of the cell-in-cell fabric 98 in a taut or stretched condition so the cutting blades 28 are efficient in cutting the sides of the inner cell of the fabric.

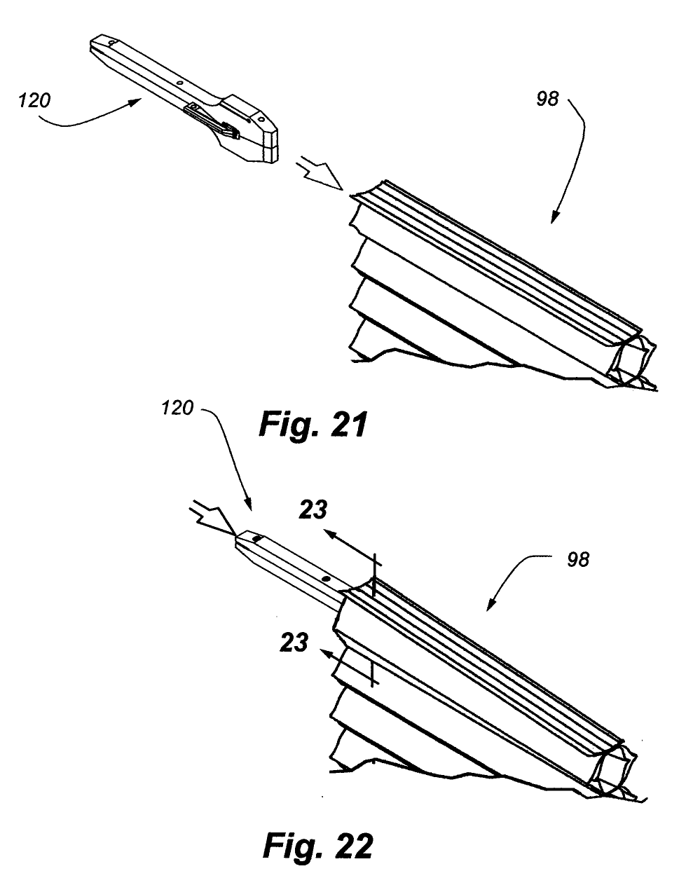

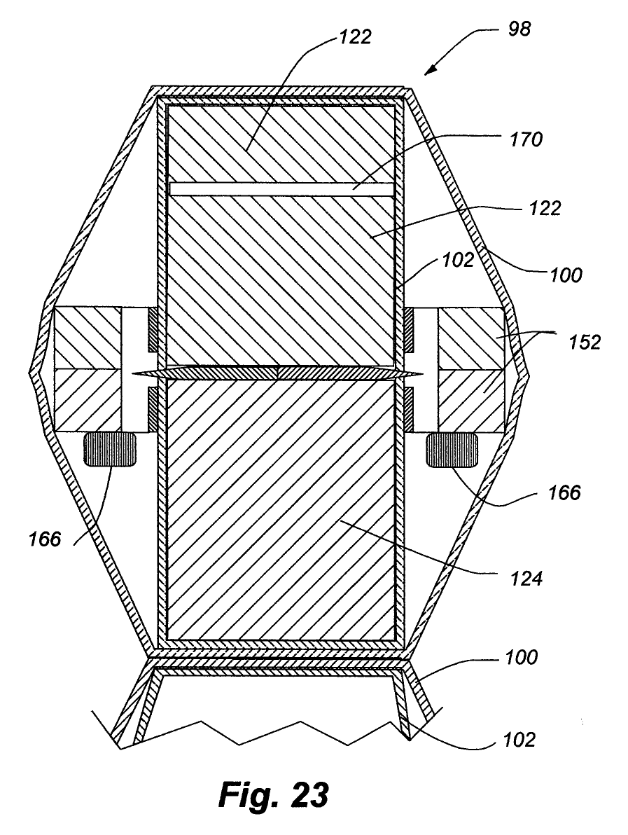

FIGS. 21 and 22 show the cutting tool 120 being positioned and then advanced into the upper cell of a cell-in-cell fabric 98 with FIG. 23 showing the tool holding the inner cell 102 in a taut or stretched condition while the cutting blades sever the innermost cell along horizontal lines into identical upper and lower halves.

It will be appreciated from the above that a cutter tool for severing the inner concentric cell of a dual cell used in a cell-in-cell covering for a architectural opening has been described which conveniently not only severs the inner cell so that an anchor bar can be placed in engagement with the outer cell but does so in a manner so the anchor bar is placed in the outer cell simultaneously with the cutting of the inner cell. Accordingly, a task, which formerly was very time consuming, can now be done very expeditiously and dependably.

Although the present invention has been described with a certain degree of particularity, it is understood the disclosure has been made by way of example, and changes in detail or structure may be made without departing from the spirit of the invention as defined in the appended claims.

1. A device for cutting an elongated inner cell without cutting an elongated outer cell surrounding said inner cell, wherein said cells are made of a flexible material comprising:
a substantially rigid main body having a transverse peripheral dimension adjacent to a leading end thereof somewhat similar to the transverse peripheral dimension of said inner cell such that said substantially rigid body can be slid longitudinally through said inner cell,
lateral extensions from opposite sides of said main body such that the transverse peripheral dimension of a hypothetical enclosure surrounding said main body and lateral extensions is somewhat similar to the transverse peripheral dimension of said outer cell so that said main body with lateral extensions can slide longitudinally through said outer cell, and
cutting blades secured to said main body extending beyond the transverse peripheral dimension of said main body but within said hypothetical enclosure such that sliding movement of said main body longitudinally through said inner cell forces said cutting blades to sever said inner cell without cutting said outer cell.

2. The device of claim 1 wherein said cutting blades are positioned within said lateral extensions.

3. The device of claim 1 wherein said main body is elongated having said leading end insertable into said inner cell and wherein said device further includes guide arms spaced from said main body adjacent to said leading end for confining a portion of said inner cell adjacent to said main body as said device is slid through said inner cell to properly position said inner cell for severance by said cutting blades.

4. The device of claim 3 wherein said guide arms are secured to said lateral extensions.

5. The device of claim 2 wherein cutting blades are secured to said main body by said lateral extensions

6. The device of claim 5 wherein said main body has two segments that are releasably interconnected so as to define a pocket therebetween in which said cutting blades are secured so as to protrude from opposite sides of said main body.

7. The device of claim 3 wherein said main body has a trailing end and said lateral extensions are secured to said main body at a location closer to said trailing end than said cutting blades.

8. The device of claim 7 wherein the transverse peripheral dimension of the main body is smaller adjacent to the trailing end of said main body than adjacent to the leading end of said main body.

9. The device of claim 1 wherein said lateral extensions are removable from said main body.

10. The device of claim 1 wherein said lateral extensions are an integral part of said main body.

11. The device of claim 1 wherein said leading end includes a flexible and resilient component.

12. The device of claim 11 wherein said flexible and resilient component is defined by a slot formed in said main body.

13. A cell in cell covering for architectural openings comprising in combination:
an upper rail,
a bottom rail, and
a fabric secured to and extending between said upper and lower rails, said fabric having a plurality of elongated concentric double cells attached to adjacent double cells along a longitudinal side with each double cell having an inner cell and an outer cell and being made of a flexible material so the cells are transversely collapsible and expandable, an uppermost double cell being connected to said upper rail and a lowermost double cell being connected to said bottom rail, each of said uppermost and lowermost double cells having its inner cell longitudinally severed, and an anchor bar within the uppermost and lowermost cells for securing said uppermost and lowermost cells to the upper and lower rails respectively.

14. The covering of claim 13 wherein said upper and bottom rails include confronting channels therein to receive side edges of said anchor bars when said anchor bars are in said uppermost and lowermost cells.

15. The covering of claim 13 wherein said inner and outer cells have front and rear pleats with the pleats of the inner cells being spaced inwardly from the pleats of the outer cells.

16. The covering of claim 13 wherein said inner and outer cells are symmetrical about a horizontal plane passing through a central longitudinal axis of the inner and outer cells.

17. The covering of claim 13 wherein said inner and outer cells are symmetrical about a vertical plane passing through a central longitudinal axis of the inner and outer cells.

18. The covering of claim 13 wherein said anchor bars in said uppermost and lowermost cells laterally fill the outer cells of said uppermost and lowermost cells.

19. The covering of claim 13 or 18 wherein said anchor bars in said uppermost and lowermost cells are slightly flexible so as to be biased within said upper and lower rails, respectively.

20. The covering of claim 14 wherein said anchor bars in said uppermost and lowermost cells are slightly flexible so as to be biased between said confronting channels in said upper and lower rails, respectively.
